(19) United States
(12) Patent Application Publication
(10) Pub. No.: US 2008/0000968 A1
(43) Pub. Date: Jan. 3, 2008

(54) Rotating Light Beam/Distance Meter Based Location Determining System

(76) Inventors: Robert Thomas Cato, Raleigh, NC (US); Hye Suk Makley, Raleigh, NC (US)

Correspondence Address: DUKE W. YEE;YEE & ASSOCIATES, P.C., P.O. BOX 802333, DALLAS, TX, 75380, US

(21) Appl. No.: 11/427,877

(22) Filed: Jun. 30, 2006

(51) Int. Cl. G06Q 30/00; G06K 15/00

(52) U.S. Cl. 235/385; 235/383

(57) ABSTRACT

A computer implemented method, system, and computer usable program code are provided for determining the location of a device. A light beam is emitted from a source to a target at a first time. A reflection of the light beam is received from the target at a second time. A distance from the source to the target is determined using the difference between the second time and the first time. An angular position of the target is identified using a position of the source when the reflected light beam was received. Polar coordinates of the target are determined using the distance from the source to the target and the angular position of the target. The light beam is encoded and then emitted from the source to the target. The target does not require power.

### BACKGROUND OF THE INVENTION

1. Field of the Invention

The present invention relates generally to location determining systems and specifically to location detection via consumer service devices (CSDs). More particularly, the present invention relates to a computer implemented method, system, and computer usable program code for enabling utilization of a consumer service device to provide location specific information within retail environments.

2. Description of the Related Art

Consumer service devices are being introduced in various environments to provide assistance to consumers. For example, in retail establishments, consumer service devices are utilized to provide customers with pre-programmed information specific to the retail establishment as a whole, such as products that are currently discounted on. These devices are used to provide information that improves the customers' overall shopping experiences.

Current use of these devices is, however, limited because of the difficulty in accurately determining the current location of the consumer service device and providing the customer with location-specific information on the fly. This location specific information may be, for example, on sale/discounted/available items in the vicinity. Providing location-specific information requires the accurate determination of the location of the consumer service device within the establishment.

One existing method for determining the current location of a consumer service device utilizes infrared (IR) beacons suspended from the ceiling of the establishment. IR beacons are typically battery-powered, and a large number of these IR beacons must be installed in a store in order to obtain the location accuracy desired to assist the consumer. Thus, the total installation cost for this implementation is high. Also, the implementation presents a maintenance problem with changing of batteries for the large number of suspended IR beacons. Hard wiring the beacons to a power source has also been suggested, but the installation is much more labor intensive.

Another method measures the amplitude of the consumer service device's wireless local area network (LAN) signals when the signals are received at multiple wireless LAN access points to determine the location of the consumer service device. However, the wireless LAN-based location systems also do not provide the location accuracy desired to be effective.

### BRIEF SUMMARY OF THE INVENTION

The different aspects of the illustrative embodiments provide a computer implemented method, system, and computer usable program for determining the location of a device. The illustrative embodiments emit a light beam from a source to a target in a first area at a first time. The illustrative embodiments receive a reflection of the light beam from the target at a second time. The illustrative embodiments determine a distance from the source to the target using the difference between the second time and the first time and then identify an angular position of the target using a position of the source when the reflected light beam was received. The illustrative embodiments determine polar coordinates of the target using the distance from the source to the target and the angular position of the target and encode the light beam with either the polar coordinates of the target and an absolute physical location of the source, or an absolute physical location of the target to form an encoded light beam. Lastly, the illustrative embodiments emit the encoded light beam from the source to the target. The target does not require power.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system is shown in which illustrative embodiments may be implemented;

FIG. 3 depicts an exemplary retail area in accordance with an illustrative embodiment;

FIG. 4 illustrates the basic structure of an exemplary rotating light beam distance meter in accordance with an illustrative embodiment;

FIG. 5 is a flowchart of the operation of a location determining system in accordance with an illustrative embodiment;

FIG. 6 illustrates an exemplary look-up table in accordance with an illustrative embodiment; and

FIG. 7 illustrates a location specific function in accordance with an illustrative embodiment.

### DETAILED DESCRIPTION OF THE INVENTION

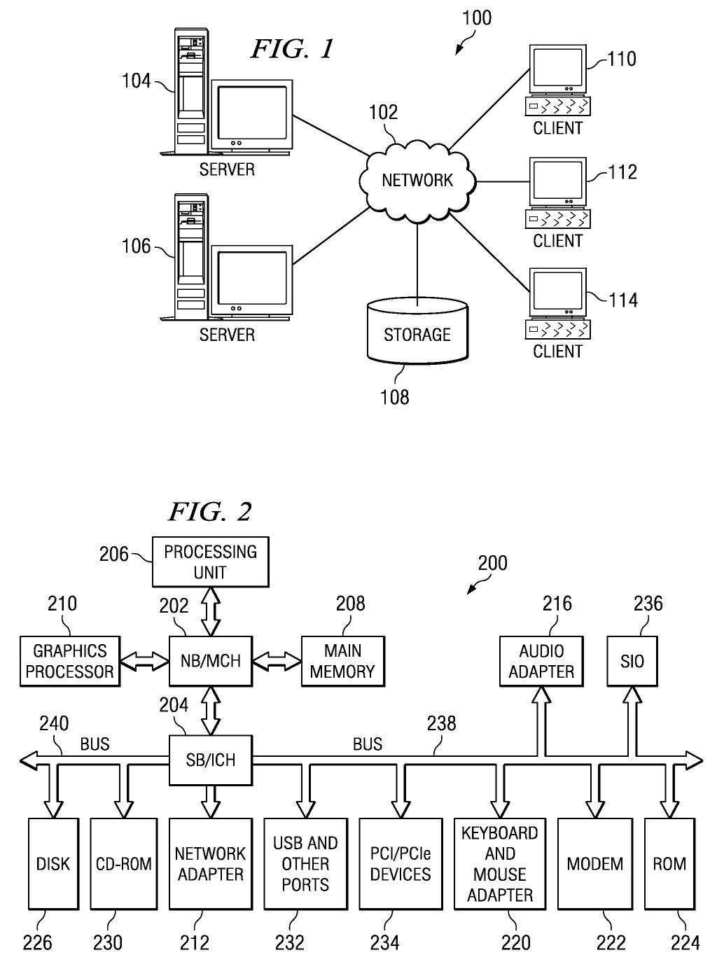

The present invention provides a method and system for providing accurate location of a consumer service device in a retail establishment via a rotating light beam distance meter. With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers, network computers, or consumer service devices. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA) or consumer service device, which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter, such as a wireless network interface device (NID) or a photo detector/digitizer device. A wireless NID may provide communications that involve: a query from client to the server for information pertaining to the client as well as other information that the client may need to store and display locally. A photo detector/digitizer device may be an internal or external component to a client. Also, photo detector/digitizer device may be subsystem similar to those utilized in light scanners, particularly when the light being reflected is modulated with information corresponding to specific locations.

A memory may be, for example, main memory 208 or a cache such as found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

The present invention provides a computer implemented method, system, and computer usable program code for accurate location for a consumer service device in a retail establishment via a rotating light beam distance meter. A plurality of location targets are hung from the ceiling of the retail establishment. The location targets are specially designed reflectors. Each location target is placed at a preset angle to reflect a light beam or other light source, such as a laser beam, back to the light beam distance meter and down to the ground below the respective location target. The rotating light beam distance meter is provided and emits a light beam to calculate polar coordinates of the location target. The rotating light beam distance meter is then modulated with either the polar coordinates of the location target and an absolute physical location of the center of the rotating light beam or an absolute physical location of the reflecting location target, which may be calculated based on the polar coordinates of the location target. The encoded light beam is then reflected by the location target to the floor.

The modulated light beam that is reflected down towards the floor is captured and/or received by a photo detector/digitizer of the consumer service device, when the consumer service device passes in the signal area of the reflected beam. When the consumer service device's photo detector/digitizer receives either the polar coordinates of the location target and the absolute physical location of the center of the rotating light beam or the absolute physical location of the reflecting location target, the consumer service device is able to use the received information to calculate that absolute physical location of the consumer service device. If the absolute physical location of the reflecting location target is received in the encoded beam, the consumer service device can skip the calculation of the absolute physical location of the consumer service device because it is the same as the absolute physical location of the reflecting location target. The absolute physical location of the consumer service device is then sent to a server application for association to an appropriate location-specific message and/or data to be utilized of displayed by the consumer service device.

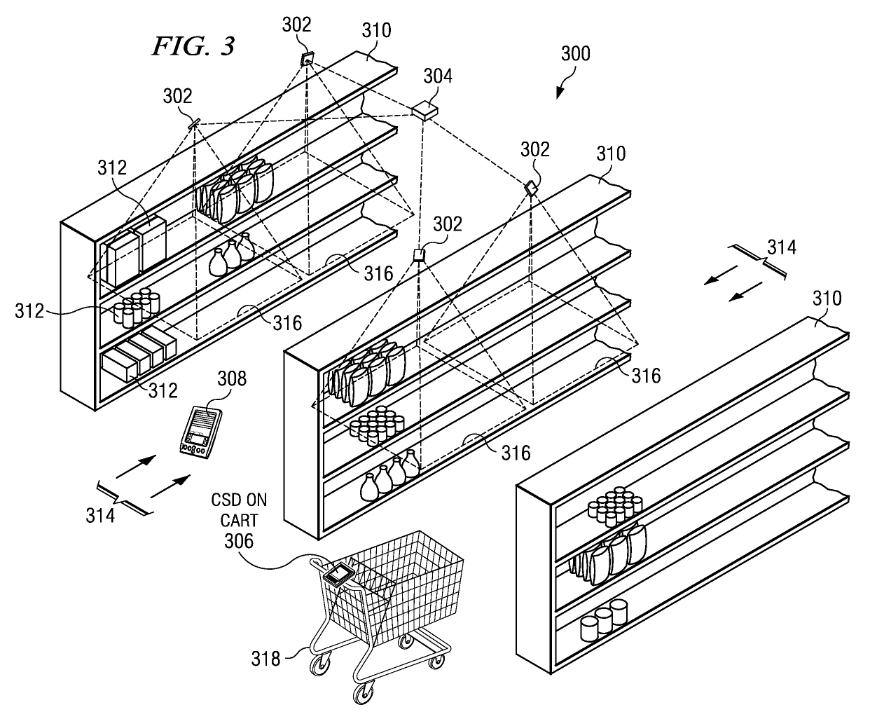

FIG. 3 depicts an exemplary retail area in accordance with an illustrative embodiment. Exemplary retail area 300 in which multiple location targets 302 and one or more of rotating light beam distance meter 304 are utilized to provide the absolute physical location that enable consumer service devices 306 and 308 to provide location-specific information to customers. Retail area 300, depicted as a grocery store-type retailer, includes a plurality of rows of shelving units 310, which may take the form of shelves, with products/items 312 placed thereon. Aisles 314 are provided between each row of shelves 310. Located at spaced intervals above each aisle 314 are a number of location targets 302. Only two are shown per aisle in the illustrative example. Location targets 302 may be extended/hung from the ceiling (not shown) of the structure housing of retail area 300. The placement of location targets 302 within retail area 300 is such that reflected light from location targets 302 covers the entire space in which consumer service devices 306 and 308 may travel. In this example, the placement is, for example, a distance from each other and at an appropriate angle of reflection. Note that the light beam reflects off a diffuse (non-specular=non-mirror like) or a retroreflective surface on the target, so the angle of reflection does not need to be very precise.

Within retail area 300 are placed several location targets 302, each of which has different polar coordinates relative to rotating light beam distance meter 304. Only four of location targets 302 are illustrated within retail area 300. However, it is understood that the number of location targets 302 may vary depending on a plurality of factors including size of retail space 300, size of individual location targets 302, strength of signal reflected by each of location targets 302, desired preciseness of location results, strength of the light beam produced by rotating light beam distance meter 304, as well as the location of location targets 302 relative to rotating light beam distance meter 304, ceiling height, etc. Each of location targets 302 must be in direct line of sight of rotating light beam distance meter 304 to enable reflection of the light beam.

As shown, each of location targets 302 reflects light into signal areas 316. Signal areas 316 represent the area in which either the polar coordinates of a particular one of location targets 302 and the absolute physical location of the center of rotating light beam distance meter 304 or the absolute physical location of the reflecting one of location targets 302 reflected by location targets 302 can be received by a photo detector/digitizer device within consumer service devices 306 and 308. Signal areas 316 may be uniform in shape and size or may be different shapes/sizes depending on the strength of the signal reflected by the particular location targets 302 or the location relative to the rotating light beam distance meter 304. For simplicity, signal areas 316 are assumed to have clearly defined borders. In practical application, however, it is probable that adjacent signal areas 316 overlap at the shared borders.

FIG. 3 also illustrates two different types of consumer service devices 306 and 308 within retail area 300. Consumer service device 306 is physically attached to customer cart 318, which is provided by the retailer and consumer service device 308 is a portable consumer service device. While either of consumer service devices 306 or 308 may be utilized, the illustrative embodiments described hereinafter utilize the portable representation of consumer service device 308.

When rotating light beam distance meter 304 emits a light beam that strikes location targets 302, location targets 302 reflects either the polar coordinates of the location target and the absolute physical location of the center of the rotating light beam or the absolute physical location of the reflecting location target, which may be calculated based on the polar coordinates of the reflecting location target, into signal areas 316 in aisles 314 below. In the illustrative embodiment, signal areas 316 are areas projected downwards below location targets 302. Different placement of location targets 302 may be provided, such as on the side of shelves 310 facing aisles 314, and the reflection of either the polar coordinates of the location target and the absolute physical location of the center of the rotating light beam or the absolute physical location of the reflecting location target from location targets 302 may then vary in shape, size, direction, and strength.

Thus, although signal areas 316 are illustrated as a rectangular-shaped area, it is understood that the signal may be projected to yield a different shaped signal area. For example, location targets 302 may also produce a cone-shaped signal area that covers a circular area of aisles 314 in front of shelves 310. In one embodiment, location targets 302 are spaced so that reflected signal areas 316 does not intersect with the signal areas of adjacent location targets 302.

The described illustrative embodiment is directed to a particular application to aid in a retail environment. While other applications are possible, the illustrative embodiments described hereinafter use this specific implementation for ease of understanding, and no functional limitations are implied by the reference to this specific implementation. Thus, although the illustrative embodiments are being described with reference to its application within a retail environment, use of location targets 302 and rotating light beam distance meter 304 to determine the location of a consumer service device via either the polar coordinates of the location target and the absolute physical location of the center of the rotating light beam or the absolute physical location of the reflecting location target may be applied to non-retail environments as well.

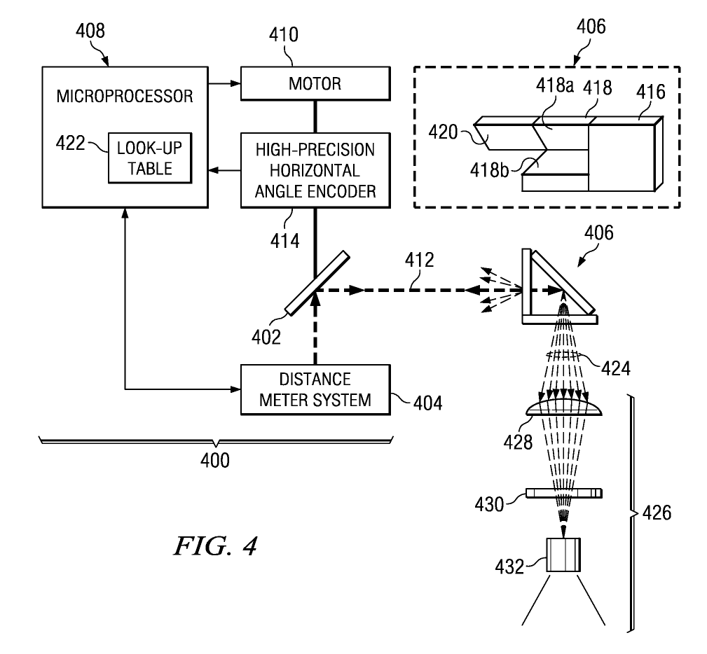

FIG. 4 illustrates the basic structure of an exemplary rotating light beam distance meter in accordance with an illustrative embodiment. Rotating light beam distance meter 400 is a rotating light beam distance meter, such as rotating light beam distance meter 304 of FIG. 3. Rotating light beam distance meter 400 is composed of mirror 402, distance meter system 404, and microprocessor 408. Mirror 402 is rotated by motor 410 to continuously sweep light beam 412 produced by distance meter system 404 to measure a distance to location targets 406. Mirror 402 is oriented at 45 degrees relative to distance meter system 404 and motor 410. The rotation of mirror 402 will reflect light beam 412 of distance meter system 404 in a circular sweep in a plane that is normal to motor 410 and distance meter system 404.

Rotating light beam distance meter 400 is located near the ceiling of a retail environment so that the plane of light beam's 412 rotation is near the ceiling of the retail environment. Negligible diffuse reflection occurs when light beam 412 hits mirror 402, such that mirror 402 is invisible to distance meter system 404. The number of rotating light beam distance meters 400 within a retail environment is a factor of several criteria including the size of the area, the number of location targets 406, relative spacing between each of location targets 406, beam strength of distance meter system 404, direct line of sight of rotating light beam distance meter 400 relative to location targets 406 within range of the beam, single directional beam path versus multiple direction or circular beam path, etc.

Distance meter system 404 provides light beam 412 that is rotated a preset number of degrees by a reflective surface, such as mirror 402, adjacent to distance meter system 404. The rotation enables disbursement/emission of between 0 to 360 degrees of light capable of sequentially hitting multiple location targets 406 in the rotational path. Also, in one embodiment, the rotating light beam 412 of distance meter system 404 hits each of multiple location targets 406 surrounding distance meter system 404 at preset intervals. According to the illustrative embodiment, distance meter system 404 emits light beam 412 along a substantially horizontal path parallel to the ceiling of the retail area.

Light beam 412 generated by distance meter system 404 may be in the visible or invisible range of light. As described below, light beam 412 may be invisible infrared (IR), in one embodiment. The range of the distance meter system 404 is dependent on design factors, which include the optics utilized to focus light beam 412 and the desired size of location targets 406. The rotating light beam 412 strikes location targets 406, such as reflector assemblies, which are mounted under the ceiling at various locations in the store, relative to distance meter system 404.

In this example, rotating light beam distance meter 400 also includes high-precision horizontal angle encoder 414 that monitors the angular position of mirror 402 as mirror 402 is rotated by motor 410. The angular position detected by high-precision horizontal angle encoder 414 is sent to microprocessor 408 for use in computing the polar coordinates of location targets 406. The absolute physical location of the center of rotating light beam distance meter 400 is input into microprocessor 408 manually or via remote configuration.

Location targets 406 are located above places in a retail environment where it is desired for a consumer service device to know its precise location. Location targets 406 may be located in any location in the retail environment as long as location targets 406 are not shadowed by another location target or another item that may block the path of light beam 412 to location targets 406.

As described in these examples, location targets 406 may be made up of two or more sections: diffuse or retroreflective reflector 416, diffuse absorber 418, and mirror 420. Diffuse reflector 416 provides an optimum reflection of light beam 412 back to distance meter system 404. Diffuse or retroreflecive reflector 416 is not required to be planar because diffuse materials reflect light in almost all directions and retroreflective materials reflect most light back to the source from which it came. Distance meter system 404 uses reflector 416 to make a precise measurement of the distance to location targets 406. Distance meter system 404 measures target distances continuously and holds measurements when the amplitude of the reflected light drops. Measurements are used to encode light beam with polar coordinates of target.

Diffuse absorber 418 absorbs a large fraction A (if not essentially all) of the incident light beam, which causes a large negative change in the amplitude of the reflection of light beam 412 after recently striking diffuse or retroreflective reflector 416, and ensures the reflection from other items in the surrounding area of the retail environment do not cause the location targets' 406 measurement to not be recorded. Diffuse absorber 418 is an optional component of location targets 406. Diffuse absorber 418 optionally has two parts: upper part 418a mounted at an angle as shown and lower part 418b mounted horizontally, which in combination would provide much more absorption. Any light that upper part absorber 418a does not absorb (1-A) would be reflected down on to lower part absorber 418b, which would absorb another high fraction (A) of the incident light. The fraction of light absorbed so far is A squared. Any light that lower part absorber 418b does not absorb would be reflected back up to upper part absorber 418a, which would absorb another high fraction (A) of that light before reflecting a tiny amount of light back to distance meter system 404. Thus, the two part absorber enables the total fraction of light absorbed by the target to be A cubed. If a single absorptive surface is used for diffuse absorber 418, it could be mounted at almost any angle, including be coplanar with diffuse reflector 416, but it would be more effective if it were angled such that any light not absorbed would not be reflected back to distance meter system 404. Thus, it could be coplanar with mirror 420. Note that absorber does not need to be diffuse, it simply must prevent light from being reflected back to distance meter system 404.

With the reflection of light beam 412 back to distance meter system 404 through mirror 402, distance meter system 404 may determine the distance to each of location targets 406 and store the information. Any offset distance to allow for the point of light beam 412 being emitted from distance meter system 404 to the point where light beam 412 hits mirror 402 would be subtracted from the distance calculation.

Microprocessor 408 can use the distance to each of location targets 406, the width of each of location targets 406, and the rate of rotation of light beam 412 to calculate the time to hold the distance measurement and encode it on light beam 412. If the distance measurements cannot be made in a predetermined period of time, microprocessor 408 could be programmed in a “set-up” or “calibration” mode to store the distance results in look-up table 422. The information for location targets 406 in look-up table 422 may then be encoded on light beam 412 as a function of rotational angle calculated by high-precision horizontal angle encoder 414. The stored location target information would be verified the next time distance meter system 404 is able to accurately determine the distance to each of location targets 406 and updated with any inconsistencies.

The angular position detected by high-precision horizontal angle encoder 414 and the distance calculated by distance meter system 404 is sent to microprocessor 408 to compute the polar coordinates of location targets 406. Either the polar coordinates of location targets 406 and the absolute physical location of the center of rotating light beam distance meter 400 or the absolute physical location of the reflecting one of location targets 406, which could be calculated based on the polar coordinates of the reflecting one of location targets 406 relative to distance meter system 404, are then encoded on light beam 412. Light beam 412 then transmits respective encoded information to location targets 406 based on the angular position detected by high-precision horizontal angle encoder 414 and the distance calculated by distance meter system 404.

Mirror 420 reflects the encoded light beam 412 down towards the floor. In order to enlarge the reflected area, such as signal areas 316 of FIG. 3, that is to enable light beam 412 to be received over a larger area, mirror 420 may be convex to spread light beam 412 over a wider physical area. Lower part absorber 418b of diffuse absorber 418 also blocks any reflections of light beam 412 that are reflected from the floor or items on or near the floor back towards location targets 406.

Reflected light 424 is light beam 412 reflected by mirror 420. Reflected light 424 is modulated with either the polar coordinates of a particular one of location targets 406 and the absolute physical location of the center of rotating light beam distance meter 400 or the absolute physical location of the reflecting one of location targets 406. Reflected light 424 is dispersed into an area, such as signal area 316 of FIG. 3, in which a consumer service device 306 or device 308 equipped with photo detector/digitizer subsystem 426 is present. The amount of dispersion is a function of the type of reflector being utilized and/or the utilization of a light diffuser.

Photo detector/digitizer subsystem 426 comprises light receiving/collection lens 428, wavelength selective filter 430, and photo detector/digitizer 432. Depending on implementation, the photo detector/digitizer subsystem 426 may be similar to that utilized in a bar code scanner. Light receiving/collection lens 428 focuses light from location targets 406 on to photo detector/digitizer 432. Filter 430 is selective to the wavelength of the light and is placed in the optical path. Photo detector/digitizer 432 is connected to circuitry, such as amplifier and digitizing circuitry found in bar code scanners. Once the modulated light is received, the consumer service device utilizes either the polar coordinates of location targets 406 and the absolute physical location of the center of rotating light beam distance meter 400 or the absolute physical location of the reflecting one of location targets 406 contained therein to compute or look-up the physical location of the consumer service device. In one embodiment, the process of looking-up the physical location is conducted similarly to the manner in which an infrared consumer service device utilizes the ID of an infrared beacon to look-up the physical location of the infrared beacon.

The usable distance between location targets 406 and photo detector/digitizer 432 is determined by the strength of the emitted light, the electro-optical design of the photo detector/digitizer 432 and location targets 406, and focusing strength of light receiving/collection lens 428.

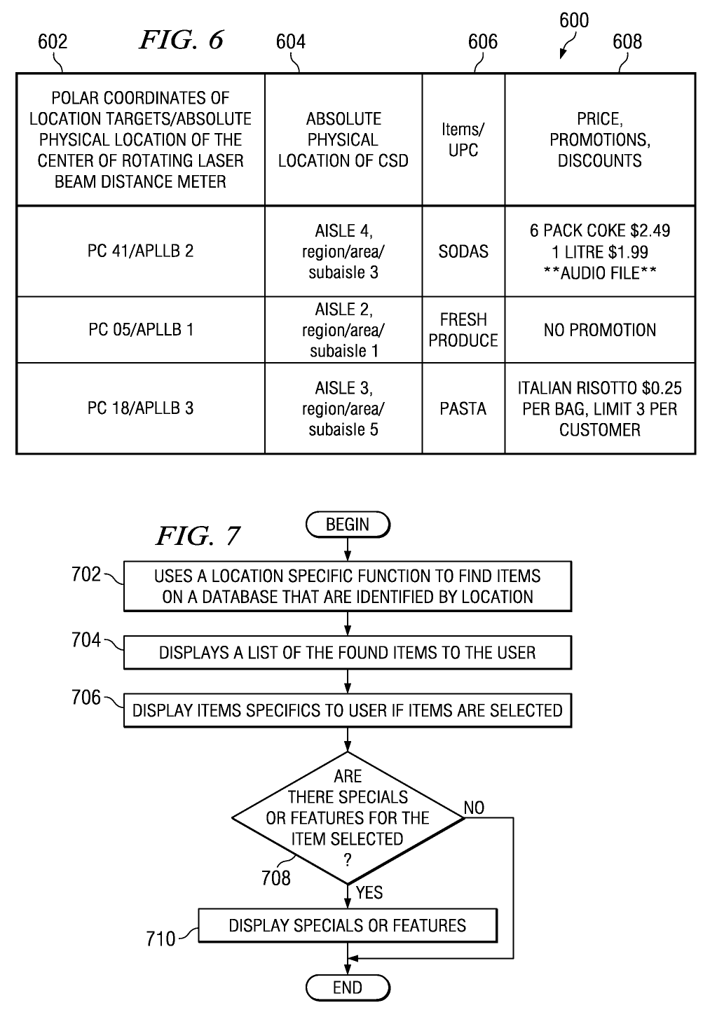

Returning now to FIG. 3, shopping cart 318 is illustrated as being customized with consumer service device 306 that is utilized to aid in locating items in retail area 300. The process by which the locating functions are completed is illustrated by FIG. 6. Before consumer service device 306 can be utilized to complete the locating functions, the device must first be programmed with an absolute physical location derivation utility. This absolute physical location derivation utility is an application program that executes on a CPU, such as processing unit 206 of FIG. 2, of consumer service device 306 and determines, calculates, or look-ups the absolute physical location of the shopping cart using the received polar coordinates of a particular one of location targets and the absolute physical location of the center of rotating light beam distance meter. If the absolute physical location of the reflecting location target is received in the encoded beam, the consumer service device can skip the calculation of the absolute physical location of the consumer service device because it is the same as the absolute physical location of the reflecting location target. An items list utility operating on consumer service device 306 may find the list of items and associated discounts, etc. within that absolute physical location and output or signal specific pre-programmed information about items at the location on a user interface of consumer service device 306.

In an alternative embodiment, while consumer service devices 306 and 308 are described as containing a items list utility, they may also communicate via a wireless network interface device (NID) to a server, such as server 104 or 106 of FIG. 1, that is running an items list utility for associating appropriate messages and/or data to the absolute physical location of consumer service device 306 or 308. The appropriate messages and/or data could then be returned by the server to consumer service device 306 or 308 to display or be utilized by consumer service device 306 or 308. Additionally, the polar coordinates of a particular one of location targets and the absolute physical location of the center of rotating light beam distance meter could also be sent to a server via consumer service device 306 or 308. The server could then run an absolute physical location derivation utility to determine, calculate, or look-up the absolute physical location of the shopping cart using the received polar coordinates of a particular one of location targets and the absolute physical location of the center of rotating light beam distance meter. The server would then run the items list utility and respond to consumer service device 306 or 308 in a manner as described previously.

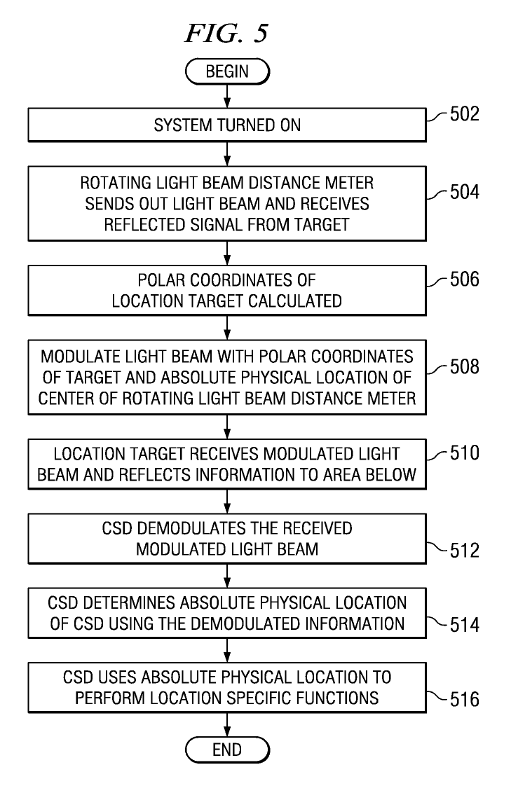

FIG. 5 is a flowchart of the operation of a location determining system in accordance with an illustrative embodiment. As the operation begins, both a rotating light beam distance meter, such as rotating light beam distance meter 400 of FIG. 4, and a consumer service device, which may be a client, such as client 110, 112 or 114 of FIG. 1, are “on” in the retail environment (step 502). The rotating light beam distance meter may be turned on when the retailer opens the retail environment to customers. Once on, the rotating light beam distance meter emits a light beam that is reflected by a location target (step 504). The distance to the target along with the angular coordinates of the mirror for the measured distance are used to calculate the polar coordinates of the location target (step 506). The light beam is then modulated to form an encoded light beam that contains either the polar coordinates of location targets and the absolute physical location of the center of rotating light beam distance meter or the absolute physical location of the reflecting location target (step 508). The encoded light beam strikes a mirror on the target and is reflected towards the floor where it is received by the photo detector/digitizer of a consumer service device (step 510). The consumer service device demodulates the encoded light beam and then forwards the demodulated information to the location determining utility executing on the processor of the consumer service device (step 512). Using the polar coordinates of a particular one of location targets and the absolute physical location of the center of rotating light beam distance meter, the location determining utility determines the absolute physical location of the consumer service device (step 514). However, if the absolute physical location of the reflecting location target is received in the encoded beam, the consumer service device can skip the calculation of the absolute physical location of the consumer service device because it is the same as the absolute physical location of the reflecting location target.

This location is then considered the absolute physical location of the shopping cart. Notably, determining the location may involve utilizing a look-up table with the polar coordinates of location targets and the absolute physical location of the center of rotating light beam distance meter paired against their physical locations. This look-up table is also a component of the location evaluation utility and is stored in memory of the consumer service device. Alternatively, determining the location may involve calculating the absolute location. The consumer service device then uses the absolute physical location to perform location specific functions (step 516), with the operation ending thereafter.

It may be undesirable to have the light beam pointed in certain directions, due to a variety of considerations. The rotating light beam distance meter could be configured to attenuate its light beam when it is pointed at pre-selected angles.

FIG. 6 illustrates an exemplary look-up table in accordance with an illustrative embodiment. Look-up table 600, which may be a look-up table such as look-up table 422 of FIG. 4, comprises several rows divided up into columns of information. These columns of information includes the polar coordinates of location targets and the absolute physical location of the center of rotating light beam distance meter 602, associated absolute physical location of consumer service device (CSD) 604, list of items/universal product code (UPC) 606, and item's price, promotions, and/or discounts 608. Using the polar coordinates of location targets and the absolute physical location of the center of rotating light beam distance meter or the absolute physical location of the reflecting location target 602, the corresponding physical location 604 can be retrieved from look-up table 600. If the absolute physical location of the reflecting location target is received in the encoded beam, the consumer service device can skip the calculation of the absolute physical location of the consumer service device because it is the same as the absolute physical location of the reflecting location target. Once physical location 604 has been identified, the table provides the list of available items 606 in that location as well pricing and other information, such as promotions and/or discounts 608 associated with specific items.

The look-up table may be provided as a software product that allows a potential customer to improve his/her shopping experience with a consumer service device-enabled shopping cart. As described above, the consumer service device may be attached to the shopping cart or a portable unit. Whether the customer purchases/leases the consumer service device or is provided one by the retailer, the consumer service device operates once the retail area is equipped with the rotating light beam distance meter and location targets.

Once the processor has determined the absolute physical location of the consumer service device, a location specific function can be performed. FIG. 7 illustrates a location specific function in accordance with an illustrative embodiment. As the operation begins, the consumer service device uses a location specific function to find items on a database that are identified by location (step 702). The consumer service device then displays a list of the found items to the user (step 704). The item specific information is then displayed to the customer if the customer selects the specific item(s) (step 706). A check is then made as to whether there are special discounts, or advertisements, or special features related to an item at that location (step 708). If there is some feature associated with one or more of the items in the location, such as a current discount on an item, that feature is outputted to the user (step 710), with the operation ending thereafter. If there are no features associated with one or more of the items in the location, the operation ends.

For example, the promotion may include a jingle, which is played on the consumer service device advertising an item in the location identified by the received absolute physical location of the consumer service device. Alternatively, a visual advertisement may be displayed on the display of the consumer service device. The promotion items may be locally stored within memory of the consumer service device or in a remote data processing device connected via a wireless network, and updates to these promotions may be provided via wireless transmission from a centralized computer system that includes a master list of items and associated promotions.

Information sent back to the customer on the consumer service device may also include:
A reminder of previously purchases items, such as may be determined through the customer loyalty card, that may be swiped on the consumer service device, the consumer service device will recognize what the customer bought during the last shopping event, and may remind the customer about purchasing items that may have been bought before, like soda, bread, eggs, etc.
Purchases items that may have complimentary items, such as pasta and pasta sauce. The consumer service device may suggest complimentary items when the customer purchases a certain item, or possibly suggest some recipe ideas for dinner that uses that certain item that they have purchased/selected, which will encourage them to buy other ingredients that are required for that recipe.

One advantage of the illustrative embodiments is that the reflectors are passive components and do not require a battery or wiring. Only the rotating light beam distance meter requires power. However, the rotating light beam distance meter does not require any communication connectors.

With the embodiment in which the light is an infrared (IR) light, a palmtop/handheld computer or cell phone with built-in IR sensor may be utilized in place of or as the consumer service device. The palmtop computer stores the location/item look-up table in memory. The available items with applicable discount or other associated data, such as price, are displayed on the palmtop's display screen. The customer is therefore alerted to the presence of the particular product on a nearby shelf or product area and provided all relevant pricing and discount information simultaneously. Typically, palmtop computers are customer owned devices.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for determining the location of a device, the computer implemented method comprising:
emitting a light beam from a source to a target in a first area at a first time;
receiving a reflection of the light beam from the target at a second time;
determining a distance from the source to the target using the difference between the second time and the first time;
identifying an angular position of the target using a position of the source when the reflected light beam was received;
determining polar coordinates of the target using the distance from the source to the target and the angular position of the target;
encoding the light beam with at least one of the polar coordinates of the target and an absolute physical location of the source, or an absolute physical location of the target to form an encoded light beam; and
emitting the encoded light beam from the source to the target.

2. The computer implemented method of claim 1, wherein the target reflects the encoded light beam into a second area in which a device exists.

3. The computer implemented method of claim 1, wherein the source and the target are located at an elevation above a second area.

4. The computer implemented method of claim 1, wherein the source is a laser device that emits a laser beam.

5. The computer implemented method of claim 1, wherein the light beam is emitted in a circular rotation towards the target.

6. The computer implemented method of claim 1, wherein the light beam is emitted towards a plurality of targets positioned around the source within range of the light beam.

7. The computer implemented method of claim 1, wherein the light beam is attenuated when it is directed at pre-selected angles.

8. The computer implemented method of claim 1, wherein the target comprises:
a first reflective surface angled to reflect the light beam from the target back to the source; and
a second reflective surface angled to reflect the encoded light beam from the source into a second area.

9. The computer implemented method of claim 2, further comprising:
receiving, by the device, the encoded light beam; and
determining, by the device, an absolute physical location of the device using the at least one of the polar coordinates of the target and the absolute physical location of the source, or the absolute physical location of the target.

10. The computer implemented method of claim 9, further comprising:
performing location specific functions by the device.

11. The computer implemented method of claim 10, wherein performing location specific functions by the device comprises:
retrieving, by the device, specific information associated with the absolute physical location of the device to form retrieved specific information; and
displaying, by the device, the retrieved specific information to a consumer.

12. The computer implemented method of claim 11, wherein retrieving the specific information associated with the absolute physical location of the device comprises:
sending, by the device, the absolute physical location of the device to a server;
retrieving, by the server, specific information associated the absolute physical location of the device from a data structure to form retrieved specific information;
transmitting, by the server, the retrieved specific information to the device; and
receiving, at the device, the retrieved specific information.

13. A product locating system, the system comprising:
a source;
a target;
a bus system;
a communications system connected to the bus system;
a memory connected to the bus system, wherein the memory includes a set of instructions; and
a processing unit connected to the bus system,
wherein the source emits a light beam to a target in a first area at a first time;
wherein the target receives a reflection of the light beam at a second time;
wherein the processing unit executes the set of instructions to determine a distance from the source to the target using the difference between the second time and the first time; identify an angular position of the target using a position of the source when the reflected light beam was received; determine polar coordinates of the target using the distance from the source to the target and the angular position of the target; and encoding the light beam with at least one of the polar coordinates of the target and an absolute physical location of the source, or an absolute physical location of the target to form an encoded light beam; and
wherein the source emits the encoded light beam to the target.

14. The system of claim 13, further comprising:
a device, wherein the device receives the encoded light beam; and
a processing unit within the device executes the set of instructions to determine an absolute physical location of the device using the at least one of the polar coordinates of the target and the absolute physical location of the source, or the absolute physical location of the target encoded in the light beam.

15. The system of claim 14, wherein the processing unit within the device executes the set of instructions to perform location specific functions.

16. The system of claim 15, wherein executing the set of instructions to perform location specific functions includes the processing unit within the device executing the set of instructions to retrieve specific information associated with the absolute physical location of the device to form retrieved specific information; and display the retrieved specific information to a consumer.

17. A computer program product comprising:
a computer usable medium including computer usable program code for determining the location of a device, the computer program product including:
computer usable program code for emitting a light beam from a source to a target in a first area at a first time;
computer usable program code for receiving a reflection of the light beam from the target at a second time;
computer usable program code for determining a distance from the source to the target using the difference between the second time and the first time;
computer usable program code for identifying an angular position of the target using a position of the source when the reflected light beam was received;
computer usable program code for determining polar coordinates of the target using the distance from the source to the target and the angular position of the target;
computer usable program code for encoding the light beam with at least one of the polar coordinates of the target and an absolute physical location of the source, or an absolute physical location of the target to form an encoded light beam; and
computer usable program code for emitting the encoded light beam from the source to the target.

18. The computer program product of claim 17, further including:
computer usable program code for receiving the encoded light beam; and
computer usable program code for determining an absolute physical location of the device using the at least one of the polar coordinates of the target and the absolute physical location of the source, or the absolute physical location of the target from the light beam.

19. The computer program product of claim 18, further including:
computer usable program code for performing location specific functions.

20. The computer program product of claim 19, wherein the computer usable program code for performing location specific functions comprises:
computer usable program code for retrieving specific information associated with the absolute physical location of the device to form retrieved specific information; and
computer usable program code for displaying the retrieved specific information to a consumer.
